(19) United States
(12) Patent Application Publication
(10) Pub. No.: US 2009/0221777 A1
(43) Pub. Date: Sep. 3, 2009

(54) PHOTOSENSITIVE RESIN COMPOSITION

(75) Inventors: Takashi Chiba, Tokyo (JP); Akio Saito, Tokyo (JP); Shigehito Asano, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: JSR CORPORATION, Chuo-ku (JP)

(21) Appl. No.: 12/298,391

(22) PCT Filed: Apr. 19, 2007
(86) PCT No.: PCT/JP2007/058550

§ 371 Date: Feb. 2, 2009

(30) Foreign Application Priority Data
Apr. 24, 2006 (JP) 2006-119591

(51) Int. Cl. C08F 22/40

(52) U.S. Cl. 526/262

(57) ABSTRACT

Disclosed is a photosensitive resin composition comprising (A) a polyimide resin, (B) a photo-acid generator, and (C) a crosslinking agent having an alkoxyalkylated amino group.

### TECHNICAL FIELD

The present invention relates to a photosensitive resin composition used for an interlayer dielectric (passivation film), a surface protecting film (overcoat film), an insulation film for high density mounting substrates, and the like of semiconductor chips. More particularly, the present invention relates to a photosensitive resin composition having excellent solubility in general solvents, capable of producing a thick film by application, being developable using an alkaline developer, capable of producing a cured product with high resolution. The resin composition is suitable for preparing a surface protecting film, an interlayer dielectric, and an insulating film for high density mounting substrates.

### BACKGROUND ART

In general, a polyimide resin possessing excellent heat resistance, mechanical characteristics, and the like is widely used as a surface protecting film or an interlayer dielectric used for semiconductor chips of electronic equipment. Along with increased integration of semiconductor chips, a number of photosensitive polyimide resins provided with photosensitivity to increase accuracy in film formation have been proposed. A side chain polymerizable negative photosensitive polyimide is one of such resins which are popularly used.

For example, Patent Document 1 discloses a photosensitive composition in which an aromatic polyimide precursor having acrylic side chains is used. However, the photosensitive composition has a problem of poor light transmittance. It is difficult to produce a thick film from the photosensitive composition. A large residual stress after curing is another problem. Furthermore, the photosensitive composition must be developed using a solvent which may cause problems related to environment and safety. Since it is necessary for the proposed composition to use an organic solvent as a developer, provision of a radiation-sensitive resin composition which can be developed using an alkali has been desired.

In order to solve these problems, a number of products have been proposed. For example, positive photosensitive polyimide compositions which can be developed by an alkali are proposed in Patent Documents 2 and 3. However, applicability of these photosensitive polyimide compositions is not necessarily good. Application to a film with a thickness of 15 μm or more, for example, is difficult. In addition, it is difficult to obtain sufficiently high resolution. For this reason, it has been difficult to find out a countermeasure to surface protecting film, an interlayer dielectric, or an insulation film used for high density mounting substrates requiring applicability to a thick film and high resolution.

Patent Document 4 proposes a negative-tone photosensitive polyimide composition which can be developed by an alkaline developer. However, the film (cured product) obtained by curing this negative-tone photosensitive composition does not necessarily have sufficient strength. For this reason, it has been also difficult to find out a countermeasure to surface protecting film, an interlayer dielectric, or an insulation film used for high density mounting boards requiring toughness of a film. There are a number of other patent applications. However, it is difficult to sufficiently satisfy the characteristics required for high integration and downsizing of semiconductor chips.

### [Patent Document 1] JP-A-63-125510

### [Patent Document 2] JP-A-3-204649

### [Patent Document 3] JP-A-3-209478

### [Patent Document 4] JP-A-2000-26603

### DISCLOSURE OF THE INVENTION

The present invention has been achieved in view of these problems in general technologies. An object of the present invention is to provide a photosensitive resin composition which has high solubility to general solvents, can produce a thick film, is developable using an alkaline developer, and can produce a cured product having excellent resolution and high mechanical strength. The resin composition is suitable for preparing a surface protecting film, an interlayer dielectric, and an insulating film for high density mounting substrates.

The inventors of the present invention have conducted extensive studies in order to achieve the above object. As a result, the inventors have found that the above object can be achieved by the following resin composition. This finding has led to the completion of the present invention.

According to the present invention, the following photosensitive resin compositions are provided.

[1] A photosensitive resin composition comprising (A) a polyimide resin, (B) a photoacid generator, and (C) a crosslinking agent having an alkoxyalkylated amino group.
[2] The photosensitive resin composition according to [1], further comprising a phenol resin.
[3] The photosensitive resin composition according to [1] or [2], wherein the polyimide resin (A) is alkali-soluble.
[4] The photosensitive resin composition according to any one of [1] to [3], wherein the polyimide resin (A) comprises a repeating unit of the following formula (1),

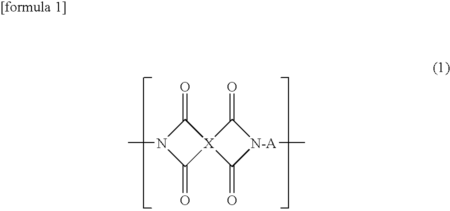

wherein X represents a tetravalent aromatic hydrocarbon group or a tetravalent aliphatic hydrocarbon group and A represents a divalent group having a hydroxyl group.
[5] The photosensitive resin composition according to [4], wherein X in the formula (1) is a tetravalent aliphatic hydrocarbon group.
[6] The photosensitive resin composition according to [4] or [5], wherein A in the formula (1) is a group shown by the following formula (2),

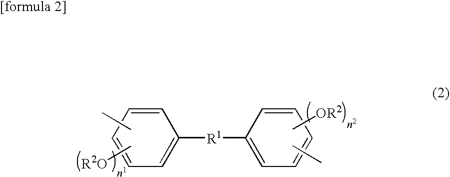

wherein R¹ represents at least one group selected from the group consisting of a single bond, an oxygen atom, a sulfur atom, a sulfone group, a carbonyl group, a methylene group, a dimethylmethylene group, and a bis(trifluoromethyl)methylene group, R² individually represents a hydrogen atom, an acyl group, or an alkyl group, and n¹ and n² represent integers from 0 to 2, provided that at least one of n¹ and n² is 1 or more and at least one of R² is a hydrogen atom.

The photosensitive resin composition of the present invention has high solubility to general solvents, can produce a thick film by application, is developable using an alkaline developer, and can produce a cured product having excellent resolution and high mechanical strength. The resin composition is suitable for preparing a surface protecting film, an interlayer dielectric, and an insulating film for high density mounting boards.

### BRIEF DESCRIPTION OF THE DRAWINGS

FIG. 1 is a schematic cross-sectional view showing a semiconductor chip having an insulating resin layer formed from the photosensitive resin composition of the present invention.

FIG. 2 is a schematic cross-sectional view showing a semiconductor chip having an insulating resin layer formed from the photosensitive resin composition of the present invention.

### EXPLANATION OF SYMBOLS

1: substrate, 2: metallic pad, 3: insulating film, 4: metal wiring, 5: insulating film

### BEST MODE FOR CARRYING OUT THE INVENTION

The preferred embodiments for carrying out the present invention are described below. However, the present invention is not restricted to the following embodiments and it should be construed that there are also included, in the present invention, those embodiments in which appropriate changes, improvements, etc. have been made to the following embodiments based on the ordinary knowledge possessed by those skilled in the art, as long as there is no deviation from the gist of the present invention.

The photosensitive resin composition of the present invention comprises (A) a polyimide resin, (B) a photoacid generator, and (C) a crosslinking agent having an alkoxyalkylated amino group. The details will be described below.

(Polyimide resin (A))

The polyimide resin (A) contained in the photosensitive resin composition of the present invention is not particularly limited inasmuch as the resin is a polymer which contains a polyimide skeleton in the molecular structure. The polyimide resin (A) is preferably alkali-soluble. As specific examples of the polyimide resin (A), a resin comprising a repeating unit of the following formula (1) can be given. In the formula (1), X is a tetravalent aromatic hydrocarbon group or a tetravalent aliphatic hydrocarbon group, preferably a tetravalent aliphatic hydrocarbon group. As examples of the tetravalent aromatic hydrocarbon group, a tetravalent group in which four hydrogen atoms on the mother skeleton of an aromatic hydrocarbon are substituted can be given.

As examples of the aromatic hydrocarbon group, the groups shown below (1) can be given.

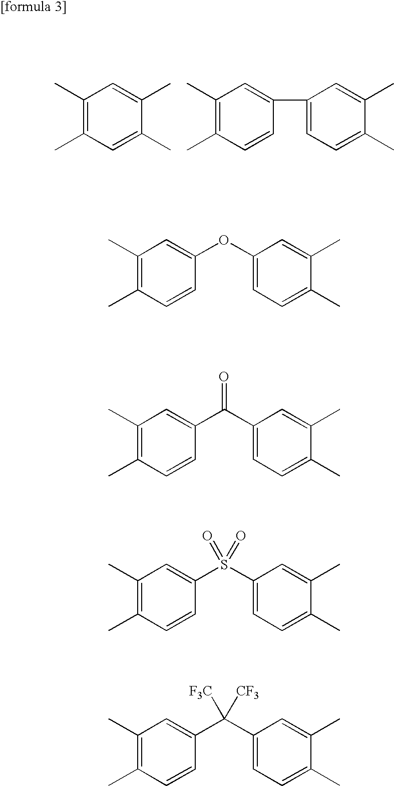

As the tetravalent aliphatic hydrocarbon group, a chain-like hydrocarbon group, an alicyclic hydrocarbon group, an alkyl alicyclic hydrocarbon group, and the like can be given. More specifically, a tetravalent group in which four hydrogen atoms on the mother skeleton of the chain hydrocarbon group, alicyclic hydrocarbon group, or alkyl alicyclic hydrocarbon group are substituted can be given. These tetravalent aliphatic hydrocarbon groups may contain an aromatic ring in at least a part of its structure. As examples of the chain hydrocarbon, ethane, n-propane, n-butane, n-pentane, n-hexane, n-octane, n-decane, and n-dodecane can be given. Specific examples of the alicyclic hydrocarbon, a monocyclic hydrocarbon, a bicyclic hydrocarbon, and a tri- or higher cyclic hydrocarbon can be given.

As examples of the monocyclic hydrocarbon, cyclopropane, cyclobutane, cyclopentane, cyclopentene, cyclohexane, cyclohexene, and cyclooctane can be given. As examples of the bicyclic hydrocarbon, bicyclo[2.2.1]heptane, bicyclo[3.1.1]heptane, bicyclo[3.1.1]hept-2-ene, bicyclo[2.2.2]octane, and bicyclo[2.2.2]oct-7-ene can be given. As examples of the tri- or higher cyclic hydrocarbon, tricyclo[5.2.1.0^{2,6}]decane, tricyclo[5.2.1.0^{2,6}]dec-4-ene, adamantane, and tetracyclo[6.2.1.1^{3,6}.0^{2,7}]dodecane can be given.

As examples of the alkyl alicyclic hydrocarbon, the above alicyclic hydrocarbon of which a hydrogen is replaced with an alkyl group such as a methyl group, an ethyl group, a propyl group, and a butyl group can be given. More specifically, methylcyclopentane, 3-ethyl-1-methyl-1-cyclohexene, 3-ethyl-1-cyclohexene, and the like can be given. As a tetravalent aliphatic hydrocarbon containing an aromatic ring in at least a part thereof, a group having three or less aromatic rings is preferable, with a group having one aromatic ring being particularly preferable. More specifically, 1-ethyl-6-methyl-1,2,3,4-tetrahydronaphthalene, 1-ethyl-1,2,3,4-tetrahydronaphthalene, and the like can be given.

As examples of the mother nucleus of a preferable tetravalent group represented by X, n-butane, cyclobutane, cyclopentane, cyclohexane, bicyclo[2.2.1]heptane, bicyclo[2.2.2]octane, bicyclo[2.2.2]oct-7-ene, and tetracyclo[6.2.1.1^{3,6}.0^{2,7}]dodecane, methylcyclopentane, and the like can be given.

The following groups may be given as more preferable examples of X.

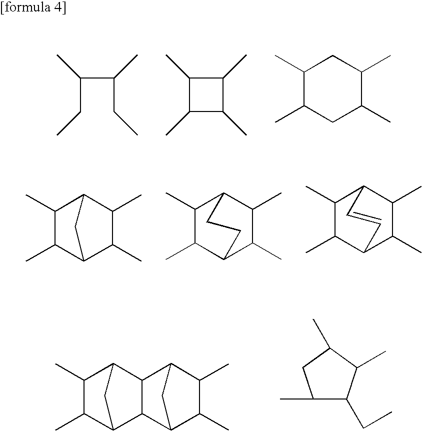

The following groups are particularly preferable examples of X.

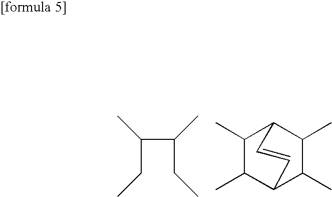

The following group is most preferable examples of X.

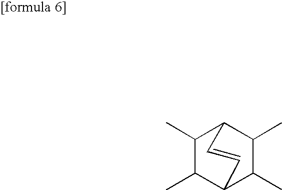

These groups may be used either individually or in combination of two or more as X.

The group indicated by A in the above formula (1) is a divalent group having a hydroxyl group. As a preferable example of the divalent group having a hydroxyl group, groups shown by the above formula (2) can be given. R¹ in the above formula (2) is at least one group selected from the group consisting of a single bond, an oxygen atom, a sulfur atom, a sulfone group, a carbonyl group, a methylene group, a dimethylmethylene group, and a bis(trifluoromethyl)methylene group. R² in the above formula (2) individually represents a hydrogen atom, an acyl group, or an alkyl group. As preferable examples of the acyl group, a formyl group, an acetyl group, a propionyl group, a butyloyl group, an isobutyloyl group, and the like can be given. As preferable examples of the alkyl group, a methyl group, an ethyl group, an n-propyl group, an isopropyl group, an n-butyl group, an n-pentyl group, an n-hexyl group, an n-octyl group, an n-decyl group, and an n-dodecyl group can be given. At least one R² is a hydrogen atom. n¹ and n² in the formula (2) represent integers from 0 to 2, provided that at least one of n¹ and n² is 1 or more.

Specific examples of the group indicated by A (divalent group having a hydroxyl group) in the above formula (1),

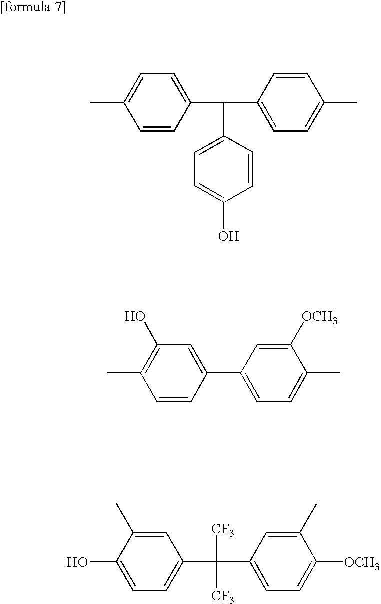

divalent groups having one hydroxyl group shown below,

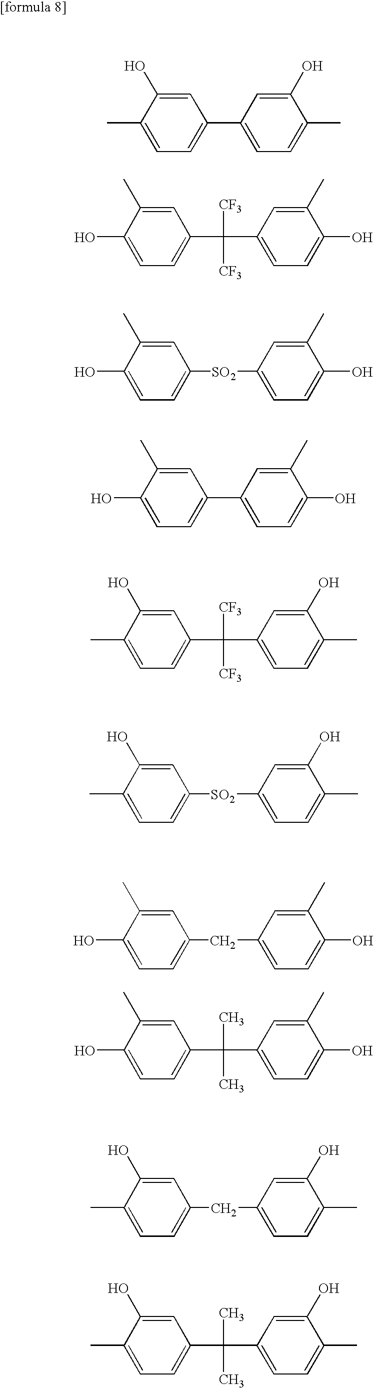

divalent groups having two hydroxyl groups shown below,

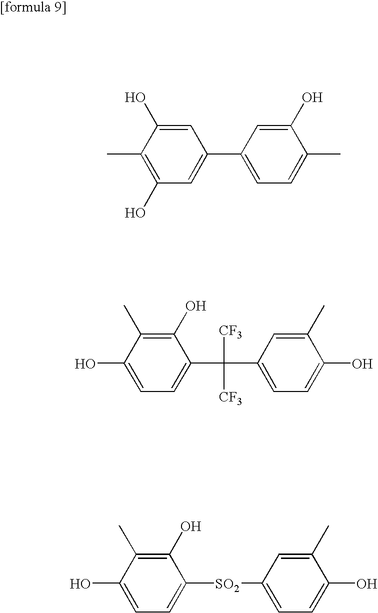

divalent groups having three hydroxyl groups shown below, and

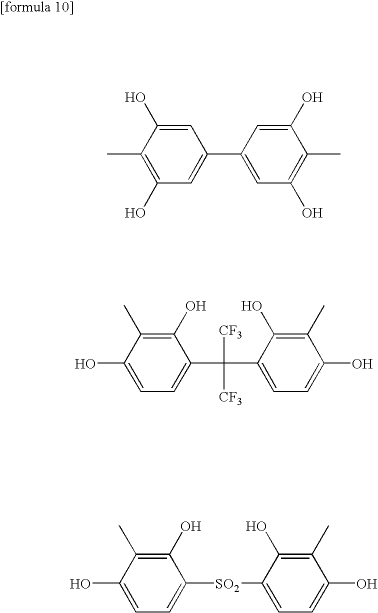

divalent groups having four hydroxyl groups shown below.

Among these, divalent groups having two hydroxyl groups are more preferable, and

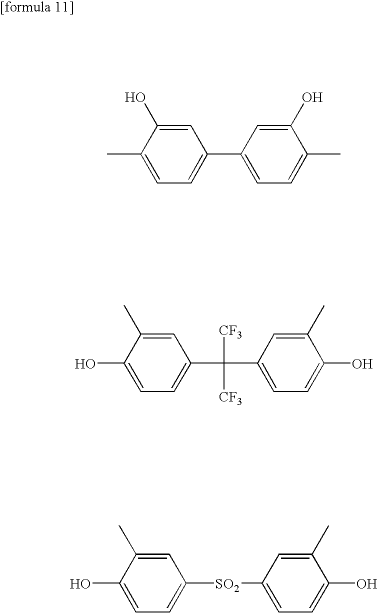

the following groups are more preferable.

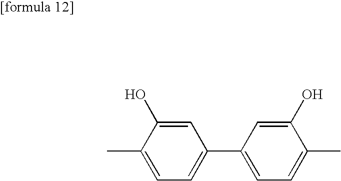

Most preferable groups are a group shown below.

The polymer (A) can be obtained in general by reacting a monomer shown by the following formula (3) (hereinafter referred to from time to time as “monomer (3)”) and a monomer shown by the following formula (4) (hereinafter referred to from time to time as “monomer (4)”) in a polymerization solvent to synthesize a polyamide acid, and imidizing the polyamide acid. The following two methods of synthesizing the polyamide acid are generally known. Either method may be employed. That is, a first method (method (i)) comprises dissolving the monomer (4) and reacting the monomer (3), and the second method (method (ii)) comprises dissolving the monomer (3) in the polymerization solvent and reacting the monomer (4).

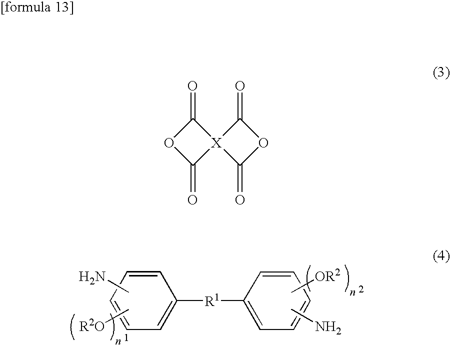

X in the formula (3) is the same as X in the above formula (1), and R¹, R², n¹, and n² in the formula (4) are the same as those in the above formula (2).

To the extent not impairing the effect of the present invention, a diamine compound other than the monomer (4) may be reacted in obtaining the polymer (A), as required. As examples of the diamine compound that may be reacted, aromatic diamines such as p-phenylenediamine, m-phenylenediamine, 4,4′-diaminodiphenylmethane, 4,4′-diaminodiphenylethane, 4,4′-diaminodiphenylsulfide, 4,4′-diaminodiphenylsulfone, 3,3′-dimethyl-4,4′-diaminobiphenyl, 4,4′-diaminobenzanilide, 4,4′-diaminodiphenyl ether, 1,5-diaminonaphthalene, 2,2′-dimethyl-4,4′-diaminobiphenyl, 5-amino-1-(4′-aminophenyl)-1,3,3-trimethylindan, 6-amino-1-(4′-aminophenyl)-1,3,3-trimethylindan, 3,4′-diaminodiphenyl ether, 3,3′-diaminobenzophenone, 3,4′-diaminobenzophenone, 4,4′-diaminobenzophenone, 2,2-bis[4-(4-aminophenoxy)phenyl]propane, 2,2-bis[4-(4-aminophenoxy)phenyl]hexafluoropropane, 2,2-bis(4-aminophenyl)hexafluoropropane, 2,2-bis[4-(4-aminophenoxy)phenyl]sulfone, 1,4-bis(4-aminophenoxy)benzene, 1,3-bis(4-aminophenoxy)benzene, 1,3-bis(3-aminophenoxy)benzene, 9,9-bis(4-aminophenyl)-10-hydroanthracene, 2,7-diaminofluorene, 9,9-bis(4-aminophenyl)fluorene, 4,4′-methylene-bis(2-chloroaniline), 2,2′, 5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 1,4,4′-(p-phenyleneisopropylidene)bisaniline, 4,4′-(m-phenyleneisopropylidene)bisaniline, 2,2′-bis[4-(4-amino-2-trifluoromethylphenoxy)phenyl]hexafluoropropane, 4,4′-diamino-2,2′-bis(trifluoromethyl)biphenyl, and 4,4′-bis[(4-amino-2-trifluoromethyl)phenoxy]-octafluorobiphenyl, and the like; and aliphatic and alicyclic diamines such as m-xylylenediamine, p-xylylenediamine, 1,3-propanediamine, tetramethylenediamine, pentamethylenediamine, hexamethylenediamine, heptamethylenediamine, octamethylenediamine, nonamethylenediamine, decamethylenediamine, dodecamethylenediamine, 4,4-diaminoheptamethylenediamine, 1,4-diaminocyclohexane, 1,4-bis(aminomethyl)cyclohexane, isophoronediamine, tetrahydro dicyclopentadienylenediamine, hexahydro-4,7-methanoindanylenediamine, tricyclo[6.2.1.0^{2,7}]-undecylenediamine, and 4,4′-methylenebis(cyclohexylamine), and the like can be given.

The following two methods of synthesizing a polyamide acid by using above-menthioned diamine compounds are generally known. Either method may be employed. That is, a first method (method (i)) comprises dissolving the monomer (4) and diamines other than the monomer (4) in a polymerization solvent, and reacting the monomer (3), and the second method (method (ii)) comprises dissolving the monomer (3) in the polymerization solvent, reacting diamines other than the monomer (4), and further reacting the monomer (4).

As examples of the polymerization solvent that can be used, non-protonic solvents such as N,N-dimethylformamide, N,N-dimethylacetamide, N-methyl-2-pyrrolidone, γ-butyrolactone, sulfolane, dimethyl sulfoxide and the like, and protonic solvents such as m-cresol and the like can be given. In addition, an alcoholic solvent such as methanol, ethanol, propanol, butanol, 2-methoxyethanol, 2-ethoxyethanol, 2-(2-methoxyethoxy)ethanol, 2-(2-ethoxyethoxy)ethanol and the like; an ether solvent such as diglyme, triglyme and the like, and an aromatic hydrocarbons solvent such as toluene, xylene and the like can be added as required.

A thermal imidization reaction and a chemical imidization reaction are generally known as a imidization reaction. It is preferable to synthesize the polymer (A) by thermal imidization reaction. The thermal imidization reaction is generally carried out by heating a solution for synthesizing the polyamide acid at 120 to 210° C. for 1 to 16 hours. As required, the reaction can be carried out while removing water from the system using an azeotropic solvent such as toluene, xylene and the like.

The polystyrene-reduced weight average molecular weight (hereinafter reffered to from time to time as “Mw”) of the polymer (A) measured by gel permeation chromatography (GPC) is usually from about 2,000 to 500,000, and preferably from about 3,000 to 300,000. If Mw is below 2,000, sufficient mechanical characteristics as an insulation film may not be obtained. If Mw exceeds 500,000, solubility of the photosensitive resin composition obtained by using the polymer (A) in a solvent or a developer tends to decrease.

The proportion of the monomer (3) in all monomers (monomer (3)+monomer (4), or monomer (3)+monomer (4)+diamine compounds other than monomer (4) when diamine compounds other than monomer (4) are included) is usually 40 to 60 mol %, and preferably 45 to 55 mol %. If the proportion of the monomer (3) in all monomers is below 40 mol % or exceeding 60 mol %, the molecular weight of the resulting polymer (A) tends to decrease. In the case when a diamine compound is used, the proportion of the monomer (4) in the total of the monomer (4) and the diamine compound is usually 1 to 99 mol %, preferably 20 to 95 mol %, and more preferably 30 to 90 mol %.

### (Other Resins)

To an extent not impairing the effect of the present invention, the photosensitive resin composition of the present invention can contain resins other than the polyimide resin (A) as required. Although not particularly limited, such other resins are preferably alkali soluble. An alkali-soluble resin which has a phenolic hydroxyl group (hereinafter referred to from time to time as “phenol resin”) is more preferable due to its capability of promoting resolution performance.

As examples of the phenol resin that can be used, a novolak resin, a polyhydroxystyrene and its copolymer, a phenol-xylylene glycol dimethyl ether condensed resin, a cresol-xylylene glycol dimethyl ether condensed resin, a phenol-dicyclopentadiene condensed resin, and the like can be given.

As specific examples of the novolak resin that can be used, a phenol/formaldehyde condensed novolak resin, a cresol/formaldehyde condensed novolak resin, a phenol naphtol/formaldehyde condensed novolak resin, and the like can be given.

The novolak resin can be obtained by condensing a phenol and an aldehyde in the presence of a catalyst. Examples of the phenols that can be used, phenol, o-cresol, m-cresol, p-cresol, o-ethylphenol, m-ethylphenol, p-ethylphenol, o-butylphenol, m-butylphenol, p-butylphenol, 2,3-xylenol, 2,4-xylenol, 2,5-xylenol, 2,6-xylenol, 3,4-xylenol, 3,5-xylenol, 2,3,5-trimethylphenol, 3,4,5-trimethylphenol, catechol, resorcinol, pyrogallol, α-naphthol, β-naphthol, and the like can be given. The aldehydes include, for example, formaldehyde, paraformaldehyde, acetaldehyde, and benzaldehyde.

There are no particular limitations to the monomers other than hydroxystyrene which form the copolymer of polyhydroxystyrene. As specific examples of the monomers, styrene derivatives such as styrene, indene, p-methoxystyrene, p-butoxystyrene, p-acetoxystyrene, p-hydroxy-α-methylstyrene and the like; (meth)acrylic acid derivatives such as (meth)acrylic acid, methyl (meth)acrylate, ethyl (meth)acrylate, n-propyl (meth)acrylate, isopropyl (meth)acrylate, n-butyl (meth)acrylate, sec-butyl (meth)acrylate, t-butyl (meth)acrylate and the like; vinyl ethers such as methyl vinyl ether, ethyl vinyl ether, n-butyl vinyl ether, t-butyl vinyl ether and the like; and acid anhydride derivatives such as maleic anhydride, itaconic anhydride and the like can be given.

The content of the phenol resin is preferably 0 to 90 parts by mass, more preferably 5 to 80 parts by mass, and particularly preferably 10 to 70 parts by mass for 100 parts by mass of the total of the polyimide resin (A) and the phenol resin (B). If below 5 parts by mass, the effect of addition of the phenol resin may not be exhibited. If exceeding 90 parts by mass, on the other hand, the mechanical strength of the film tends to decrease.

The photosensitive resin composition can further contain a low molecular weight phenolic compound in addition to the phenol resin. As specific examples of the low molecular weight phenolic compound that can be contained, 4,4′-dihydroxydiphenylmethane, 4,4′-dihydroxydiphenyl ether, tris(4-hydroxyphenyl)methane, 1,1-bis(4-hydroxyphenyl)-1-phenylethane, tris(4-hydroxyphenyl)ethane, 1,3-bis[1-(4-hydroxyphenyl)-1-methylethyl]benzene, 1,4-bis[1-(4-hydroxyphenyl)-1-methylethyl]benzene, 4,6-bis[1-(4-hydroxyphenyl)-1-methyethyl]-1,3-dihydroxybenzene, 1,1-bis(4-hydroxyphenyl)-1-[4-{1-(4-hydroxyphenyl)-1-methylethyl}phenyl]ethane, 1,1,2,2-tetra-(4-hydroxyphenyl)ethane, and the like can be given.

The content of the low molecular weight phenolic compound is preferably 0 to 100 parts by mass, more preferably 1 to 60 parts by mass, and particularly preferably 5 to 40 parts by mass for 100 parts by mass of the polyimide resin (A) (or 100 parts by mass of the polyimide resin (A) and other polymers, when such other polymers are included in the polymer (A)). If below 1 part by mass, the effect of addition of the low molecular weight phenolic compound may not be exhibited. If exceeding 100 parts by mass, on the other hand, the mechanical strength of the film tends to decrease.

### (Photoacid Generator (B))

The photoacid generator (B) contained in the photosensitive resin composition of the present invention is a compound which generates an acid upon irradiation (hereinafter referred to from time to time as “exposure”). As such a photoacid generator (B), a chemically amplified-type photoacid generator such as an iodonium salt compound, a sulfonium salt compound, a sulfone compound, a sulfonate compound, a halogen-containing compound, a sulfonimide compound, a diazomethane compound, and the like; and a naphthoquinonediazido (NQD)-type photoacid generator such as a diazoketone compound and the like can be given.

As examples of the iodonium salt compounds, diphenyliodonium trifluoromethanesulfonate, diphenyliodonium nonafluorobutanesulfonate, diphenyliodonium pyrenesulfonate, diphenyliodonium dodecylbenzenesulfonate, diphenyliodonium hexafluoroantimonate, bis(4-t-butylphenyl)iodonium trifluoromethanesulfonate, bis(4-t-butylphenyl)iodonium nonafluorobutanesulfonate, bis(4-t-butylphenyl)iodonium camphorsulfonate, bis(4-t-butylphenyl)iodonium p-toluenesulfonate, and the like can be given.

As examples of the sulfonium salt compounds, triphenylsulfonium trifluoromethanesulfonate, triphenylsulfonium nonafluorobutanesulfonate, triphenylsulfonium camphorsulfonate, triphenylsulfonium naphthalenesulfonate, 4-hydroxyphenylbenzylmethylsulfonium p-toluenesulfonate, 4-(phenylthio)phenyldiphenylsulfonium hexafluorophosphate, 4,7-di-n-butoxy-1-naphthyltetrahydrothiophenium trifluoromethanesulfonate, 4,7-di-n-hydroxy-1-naphthyltetrahydrothiophenium trifluoromethanesulfonate, 4,7-di-n-butoxy-1-naphthyltetrahydrothiophenium hexafluorophosphate, 4-n-butoxy-1-naphthyltetrahydrothiophenium trifluoromethanesulfonate, and the like can be given.

As examples of the sulfone compounds, β-ketosulfone, β-sulfonylsulfone, α-diazo compounds of these compounds, and the like can be given. More specifically, phenacylphenylsulfone, mesitylphenacylsulfone, bis(phenylsulfonyl)methane, 4-trisphenacylsulfone, and the like can be given.

As examples of the sulfonate compounds, alkyl sulfonate, haloalkyl sulfonate, aryl sulfonate, imino sulfonate, and the like can be given. More specifically, benzointosylate, pyrogallol tristrifluoromethanesulfonate, pyrogallol methanesulfonic acid triester, nitrobenzyl-9,10-diethoxyanthracene-2-sulfonate, α-methylolbenzointosylate, α-methylolbenzoin octanesulfonate, α-methylolbenzoin trifluoromethanesulfonate, α-methylolbenzoin dodecylsulfonate, and the like can be given.

As examples of the halogen-containing compound, haloalkyl group-containing hydrocarbon compounds, haloalkyl group-containing heterocyclic compounds, and the like can be given. As specific examples of preferable halogen-containing compounds, 1,1-bis(4-chlorophenyl)-2,2,2-trichloroethane, phenyl-bis(trichloromethyl)-s-triazine, 4-methoxyphenyl-bis(trichloromethyl)-s-triazine, styryl-bis(trichloromethyl)-s-triazine, 4-methoxystyryl-bis(trichloromethyl)-s-triazine, naphthyl-bis(trichloromethyl)-s-triazine and the like, and s-triazine derivatives shown by the following formula (5) can be given.

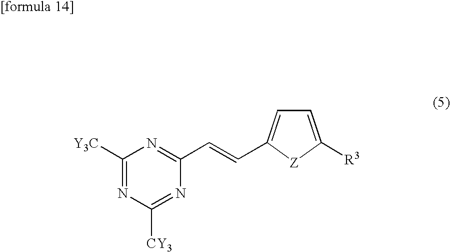

In the formula (5), R³ indicates a hydrogen atom, an alkyl group having 1 to 4 carbon atoms, or an alkoxyl group having 1 to 4 carbon atoms, Y indicates a halogen atom, and Z represents an oxygen atom or a sulfur atom.

The s-triazine derivatives shown by the formula (5) has a large absorption in g line, h line, and i line regions, and can produce an insulating cured product with higher acid generating efficiency and higher film residual rate as compared with general photoacid generators having other triazine skeletons. As examples of the alkyl group having 1 to 4 carbon atoms represented by R³ in the formula (5), a methyl group, an ethyl group, an n-propyl group, an i-propyl group, an n-butyl group, an iso-butyl group, a sec-butyl group, a tert-butyl group, and the like can be given. As examples of the alkoxy group having 1 to 4 carbon atoms, a methoxy group, an ethoxy group, a propoxy group, an iso-propoxy group, n-butoxy group, an i-butoxy group, a sec-butoxy group, and the like can be given. In the formula (5), R³ is preferably a hydrogen atom or an alkyl group having 1 to 4 carbon atoms, particularly preferably a hydrogen atom, a methyl group, or an ethyl group.

As the halogen atom represented by X in the formula (5), a fluorine atom, a chlorine atom, a bromine atom, and an iodine atom are preferable, with a chlorine atom being more preferable. Y in the formula (5) is preferably an oxygen atom.

As specific examples of the preferable s-triazine derivatives shown by the formula (5), 2-[2-(furan-2-yl)ethenyl]-4,6-bis(trichloromethyl)-s-triazine (Z=O, R³═H, Y═Cl), 2-[2-(5-methylfuran-2-yl)ethenyl]-4,6-bis(trichloromethyl)-s-triazine (Z=O, R³═CH₃, Y═Cl), and the like can be given. These s-triazine derivatives can be used individually or in combination of two or more.

As specific examples of the sulfonimide compounds, N-(trifluoromethylsulfonyloxy)succinimide, N-(trifluoromethylsulfonyloxy)phthalimide, N-(trifluoromethylsulfonyloxy)diphenylmaleimide, N-(trifluoromethylsulfonyloxy)bicyclo[2.2.1]hept-5-ene-2,3-dicarboxylmide, N-(trifluoromethylsulfonyloxy)naphthylimide, and the like can be given.

As the diazomethane compounds, bis(trifluoromethylsulfonyl)diazomethane, bis(cyclohexylsulfonyl)diazomethane, bis(phenylsulfonyl)diazomethane, and the like can be given.

As the diazoketone compounds, 1,3-diketo-2-diazo compounds, diazobenzoquinone compounds, diazonaphthoquinone compounds, and the like can be given. As specific examples of the preferable diazoketone compounds, 1,2-naphthoquinonediazido-4-sulfonate compounds of phenols can be given.

Among the above-mentioned compounds, sulfonium salt compounds, sulfone compounds, halogen-containing compounds, diazoketone compounds, sulfonimide compounds, and diazomethane compounds are preferable, and sulfonium salt compounds and halogen-containing compounds are more preferable. Particularly preferably compounds are 4-(phenylthio)phenyldiphenylsulfonium hexafluorophosphate, 4,7-di-n-butoxy-1-naphthyltetrahydrothiophenium trifluoromethanesulfonate, 4,7-di-n-hydroxy-1-naphthyltetrahydrothiophenium trifluoromethanesulfonate, 4,7-di-n-butoxy-1-naphthyltetrahydrothiophenium hexafluorophosphate, 4-n-butoxy-1-naphthyltetrahydrothiophenium trifluoromethanesulfonate, 4-methoxyphenyl-bis(trichloromethyl)-s-triazine, styryl-bis(trichloromethyl)-s-triazine, 4-methoxystyryl-bis(trichloromethyl)-s-triazine, 2-[2-(furan-2-yl)ethenyl]-4,6-bis(trichloromethyl)-s-triazine (Z=O, R³═H, Y═Cl), and 2-[2-(5-methylfuran-2-yl)ethenyl]-4,6-bis(trichloromethyl)-s-triazine (Z=O, R³═CH₃, Y═Cl). These photoacid generators (B) may be used individually or in combination of two or more.

The content of the photoacid generator (B) is usually 0.1 to 20 parts by mass, and preferably 0.5 to 10 parts by mass for 100 parts by mass of the polyimide resin (A) or 100 parts by mass of the polyimide resin (A) and other polymers when such other polymers are included in the polyimide resin (A). If the content is below 0.1 parts by mass, it may be difficult to cause sufficient chemical change by the catalytic action of the acid generated by exposure. A content of the photoacid generator (D) exceeding 20 parts by mass may cause problems such as uneven coating of the resulting photosensitive resin composition or low insulating properties of the cured products.

### (Crosslinking Agent (C))

The crosslinking agent (C) is a compound which forms a bond with components in the composition such as a resin and other molecules of crosslinking agents. As specific examples of the crosslinking agent (C), a polyfunctional (meth)acrylate compound, an epoxy compound, a hydroxymethyl group-substituted phenolic compound, a compound having an alkoxyalkylated amino group, and the like can be given. Of these, the compound having an alkoxyalkylated amino group is preferable. These crosslinking agents (C) may be used individually or in combination of two or more.

As examples of the polyfunctional (meth)acrylate compound, trimethylolpropane tri(meth)acrylate, ditrimethylolpropane tetra(meth)acrylate, pentaerythritol tri(meth)acrylate, pentaerythritol tetra(meth)acrylate, dipentaerythritol penta(meth)acrylate, dipentaerythritol hexa(meth)acrylate, glycerol tri(meth)acrylate, tris(2-hydroxyethyl)isocyanurate tri(meth)acrylate, ethylene glycol di(meth)acrylate, 1,3-butanediol di(meth)acrylate, 1,4-butanediol di(meth)acrylate, 1,6-hexanediol di(meth)acrylate, neopentyl glycol di(meth)acrylate, diethylene glycol di(meth)acrylate, triethylene glycol di(meth)acrylate, dipropyrene glycol di(meth)acrylate, bis(2-hydroxyethyl)isocyanulate di(meth)acrylate, and the like can be given.

As examples of the epoxy compound, a novolak epoxy resin, a bisphenol epoxy resin, an alicyclic epoxy resin, an aliphatic epoxy resin, and the like can be given.

As examples of the hydroxymethyl group-substituted phenolic compound, 2-hydroxymethyl-4,6-dimethylphenol, 1,3,5-trihydroxymethylbenzene, 3,5-dihydroxydimethyl-4-methoxytoluene[2,6-bis(hydroxymethyl)-p-cresol], and the like can be given.

As examples of the compound having an alkoxyalkylated amino group, nitrogen-containing compounds having two or more active methylol groups such as (poly)methylolated melamine, (poly)methylolated glycoluril, (poly)methylolated benzoguanamine, and (poly)methylolated urea, of which at least one hydrogen atom of the hydroxyl groups in the methylol group is replaced with an alkyl group such as a methyl group and a butyl group, can be given. The compound having an alkoxyalkylated amino group may be a mixture of two or more substituted compounds and may include partly self-condensed oligomers. Such a mixture of two or more substituted compounds and partly self-condensed oligomers can also be used.

As more specific examples of the compound having an alkoxyalkylated amino group, compounds shown by the following formulas (6) to (12), and the like can be given.

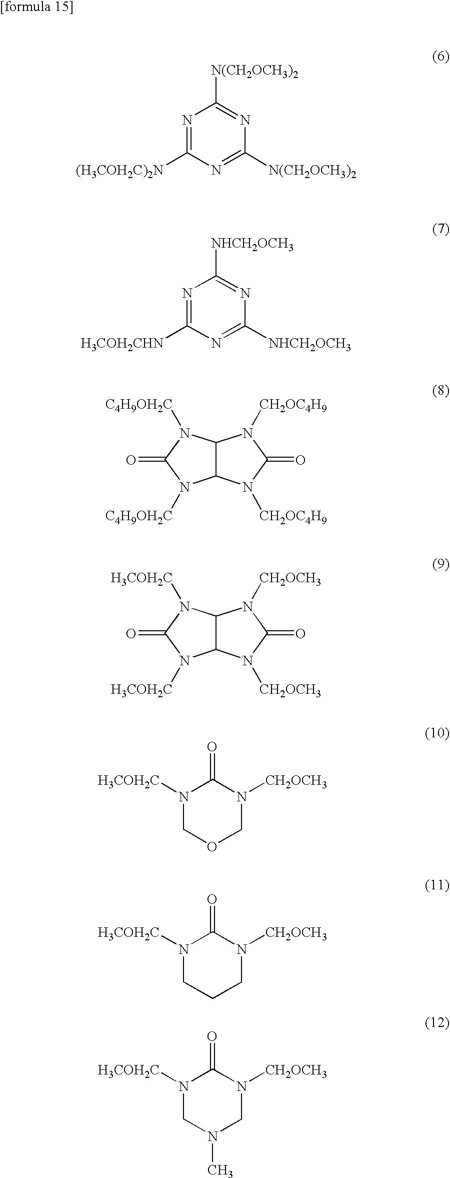

The compound of the above formula (6) (hexakis(methoxymethyl)melamine is commercially available under the commercial name of “Cymel 300” (manufactured by Cytec Industries). The compound of the above formula (8) (tetrakis(butoxymethyl)glycoluril is commercially available under the commercial name of “Cymel 1170” (manufactured by Cytec Industries).

As the compounds having an alkoxyalkylated amino group, hexakis(methoxy)methylated melamine (above formula (6)), tetrakis(methoxy)methylated glycoluril (above formula (9)), and tetrakis(butoxy)methylated glycoluril (above formula (8) are particularly preferable, with the hexakis(methoxy)methylated melamine (above formula (6)) being most preferable.

The content of the crosslinking agent (C) is appropriately determined in a range necessary for sufficiently curing the film formed from the photosensitive resin composition. The content of the crosslinking agent (C) is usually 5 to 50 parts by mass, and preferably 10 to 40 parts by mass for 100 parts by mass of the polyimide resin (A) or 100 parts by mass of the polyimide resin (A) and other polymers when such other polymers are included in the polyimide resin (A). If below 5 parts by mass, the resulting insulating layer may have insufficient solvent resistance and plating solution resistance. If exceeding 50 parts by mass, developability of the thin film formed from the photosensitive resin composition may be insufficient.

### (Solvent)

To the extent not impairing the effect of the present invention, the photosensitive resin composition of the present invention can contain an organic solvent, if required in order to improve handling easiness and adjusting the viscosity and storage stability. There are no specific limitations to the type of the solvent that can be added. Non-protonic solvents such as N,N-dimethylformamide, N,N-dimethylacetamide, N-methyl-2-pyrrolidone, γ-butyrolactone, dimethyl sulfoxide and the like, and phenolic protonic solvents such as m-cresol and the like can be preferably used.

In place of or together with the above solvents, the photosensitive resin composition of the present invention can contain organic solvents such as propylene glycol monoalkyl ethers, propylene glycol dialkyl ethers, propylene glycol monoalkyl ether acetates, aliphatic alcohols, lactic acid esters, aliphatic carboxylic acid esters, alkoxyaliphatic carboxylic acid esters, ketones, and the like.

As propylene glycol monoalkyl ethers, propylene glycol monomethyl ether, propylene glycol monoethyl ether, propylene glycol monopropyl ether, propylene glycol monobutyl ether, and the like can be given. As propylene glycol dialkyl ethers, propylene glycol diethyl ether, propylene glycol dipropyl ether, propylene glycol dibutyl ether, and the like can be given.

As propylene glycol monoalkyl ether acetates, propylene glycol monomethyl ether acetate, propylene glycol monoethyl ether acetate, propylene glycol monopropyl ether acetate, propylene glycol monobutyl ether acetate, and the like can be given. As aliphatic alcohols, 1-butanol, 2-butanol, 1-pentanol, 2-pentanol, 4-methyl-2-pentanol, 1-hexanol, and the like can be given.

As lactic acid esters, methyl lactate, ethyl lactate, n-propyl lactate, i-propyl lactate, and the like can be given. As aliphatic carboxylic acid esters, n-propyl acetate, i-propyl acetate, n-butyl acetate, i-butyl acetate, n-amyl acetate, i-amyl acetate, i-propyl propionate, n-butyl propionate, i-butyl propionate, and the like can be given.

As alkoxyaliphatic carboxylic acid esters, methyl 3-methoxypropionate, ethyl 3-methoxypropionate, methyl 3-ethoxypropionate, ethyl 3-ethoxypropionate, and the like can be given. As ketones, 2-heptanone, 3-heptanone, 4-heptanone, cyclopentanone, cyclohexanone, and the like can be given.

Of these solvents, ethyl lactate, 2-heptanone, cyclohexanone, propylene glycol monomethyl ether, propylene glycol monomethyl ether acetate, and butyl acetate are preferable, and ethyl lactate and propylene glycol monomethyl ether are particularly preferable. These solvents may be used either individually or in combination of two or more. The solvent (C) is added in an amount to make the content of the total of all components other than the solvent (C) to 1 to 60% by mass.

### (Other Additives)

To the extent not impairing the effect of the present invention, the photosensitive resin composition of the present invention can contain other additives such as a basic compound, an adherence assistant, and a surfactant, as required.

### (Basic Compound)

As examples of the basic compound, trialkylamines such as triethylamine, tri-n-propylamine, tri-n-butylamine, tri-n-pentylamine, tri-n-hexylamine, tri-n-heptylamine, tri-n-octylamine, tri-n-nonylamine, tri-n-decylamine, tri-n-dodecylamine, n-dodecyldimethylamine, and the like; nitrogen-containing heterocyclic compounds such as pyridine, pyridazine, and imidazole; and the like can be given. The content of the basic compound is usually 5 parts by mass or less, and preferably 3 parts by mass or less for 100 parts by mass of the polymer (A). If the content of the basic compound exceeds 5 parts by mass for 100 parts by mass of the polymer (A), the photoacid generator may not sufficiently exhibit its effect.

### (Adherence Assistant)

The photosensitive resin composition of the present invention can contain an adherence assistant which promotes adherence to a substrate. A functional silane coupling agent is effective as the adherence assistant. The functional silane coupling agent refers to a silane coupling agent having a reactive substituent such as a carbonyl group, a methacryloyl group, an isocyanate group, an epoxy group, and the like. As specific examples, trimethoxysilylbenzoic acid, γ-methacryloxypropyltrimethoxysilane, vinyltriacetoxysilane, vinyltrimethoxysilane, γ-isocyanatepropyltriethoxysilane, γ-glycidoxypropyltrimethoxysilane, β-(3,4-epoxycyclohexyl)ethyltrimethoxysilane, and the like can be given. The content of the adherence assistant is preferably 10 parts by mass or less for 100 parts by mass of the polymer (A).

### (Surfactant)

A surfactant can be added to the photosensitive resin composition of the present invention in order to increase applicability, defoamability, leveling properties, and the like. As examples of the surfactant, commercially available fluorine-containing surfactants such as BM-1000, and BM-1100 (manufactured by BM Chemie), Megafac F142D, F172, F173, and F183 (manufactured by Dainippon Ink and Chemicals, Inc.), Fluorad FC-135, FC-170C, FC-430, and FC-431 (manufactured by Sumitomo 3M, Ltd.), Surflon S-112, S-113, S-131, S-141, and S-145 (manufactured by Asahi Glass Co., Ltd.), SH-28PA, SH-190, SH-193, SZ-6032, and SF-8428 (manufactured by Toray-Dow Corning Silicone Co., Ltd.), and the like can be given. The content of the surfactant is preferably 5 parts by mass or less for 100 parts by mass of the polymer (A).

The photosensitive resin composition of the embodiment of the present invention is particularly suitable for use as a surface protecting film and an interlayer dielectric material of semiconductor chips. A coated film is formed by applying the photosensitive resin composition of the embodiment of the present invention to a substrate (copper foil attached to resin, copper clad substrate, silicon wafer and alumina substrate with metal spattering film attached thereto, etc.) and drying, then volatilizing the solvent and the like. The film is then exposed to radiation through a desired mask pattern and treated with heat (hereinafter, this heat treatment is called “PEB”) to promote the reaction of the phenol ring with the crosslinking agent. Next, the exposed resist film is developed using an alkaline developer to dissolve and remove unexposed areas, whereby a desired pattern is obtained. A cured film can be obtained by further heat treatment to induce insulating characteristics.

As examples of the method for applying the photosensitive resin composition to a substrate, a dipping method, a spraying method, a bar coating method, a roll coating method, a spin coating method, and the like can be used. The thickness of coating can be suitably adjusted by controlling the method of coating and the solid concentration and viscosity of the solution of the composition. Usually, a prebaking treatment is carried out in order to volatilize the solvent. The prebaking is carried out usually at 70 to 150° C., and preferably 80 to 140° C. for about 1 to 60 minutes, although the heating conditions may vary according to the composition of the photosensitive resin composition, the film thickness, and the like.

As radiation used for exposure, ultraviolet radiation, electron beams, laser beams such as g line, I line, and the like emitted from a low-pressure mercury lamp, a high-pressure mercury lamp, and a metal halide lamp can be given. The dose is appropriately selected according to the light source and the thickness of the resin film used usually from a range of about 100 to 5000 mJ/cm² g, when ultraviolet radiation is applied from a high-pressure mercury lamp to a resin film with a thickness of 10 to 50 μm, for example.

After exposure, PEB is carried out to accelerate the curing reaction of a phenol ring and crosslinking agent (C) which is induced by an acid generated. The PEB is carried out usually at 70 to 150° C., and preferably 80 to 140° C. for about 1 to 60 minutes, although the heating conditions may vary according to the composition of the photosensitive resin composition, the film thickness, and the like. Next, the exposed resist film is developed using an alkaline developer to dissolve and remove unexposed areas, whereby a desired pattern is obtained. Shower development, spray development, immersion development, paddle development, and the like may be given as the method of development. Development conditions of 20 to 40° C. for about 1 to 10 minutes may be usually employed.

An alkaline aqueous solution in which an alkaline compound such as sodium hydroxide, potassium hydroxide, ammonia water, tetramethylammonium hydroxide, or choline is dissolved in water to a concentration of 1 to 10 mass %, for example, can be given as the alkaline developing solution. An appropriate amount of a water-soluble organic solvent such as methanol and ethanol, a surfactant, and the like can be added to the alkaline aqueous solution. The film is washed with water and dried after development using the alkaline developing solution.

After development, the film can be sufficiently cured by a further heat treatment to induce sufficient performance as an insulating film. The curing conditions are not particularly limited. The photosensitive resin composition may be cured by heating at 100 to 400° C. for about 30 minutes to 10 hours according to application of the cured product. A multistage heating can be used in order to sufficiently accelerate the curing and to prevent deformation of the resulting pattern. When multistage heating is used, the product may be heated, for example, at 50 to 200° C. for about 5 minutes to 2 hours in a first stage, and at 100 to 400° C. for about 10 minutes to 10 hours in a second stage. When such curing conditions are used, a hot plate, an oven, an infrared kiln, a microwave oven, and the like can be used as heating equipment.

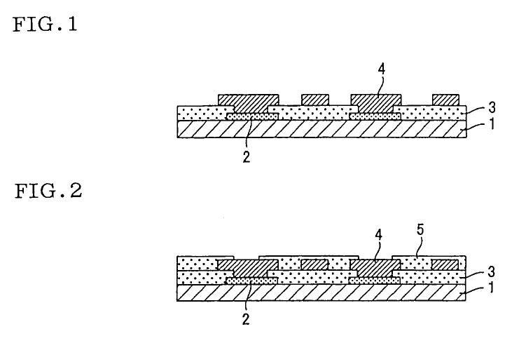

Next, a semiconductor chip in which the photosensitive resin composition of the present invention is used will be described referring to drawings. As shown in FIG. 1, a patterned insulating film 3 is formed using the photosensitive resin composition of the present embodiment on a substrate 1 on which a patterned metallic pad 2 is formed. A semiconductor chip can be obtained by forming metal wiring 4 connected to the metal pad 2.

A patterned insulating film 5 may be formed using the photosensitive resin composition of the present embodiment on the metal wiring 4 as shown in FIG. 2. A semiconductor chip having an insulating resin layer formed from the photosensitive resin composition of the present invention can be obtained in this manner.

### EXAMPLES

The present invention is described below in detail by way of examples. Note that the present invention is not limited to the following examples. In the examples, “part(s)” means “part(s) by mass” and “%” means “% by mass” unless otherwise indicated. The methods used for measuring and evaluating various properties were as follows.

[Molecular weight (Mw)]: The Mw was measured by gel permeation chromatography (GPC) using GPC columns (one TSKgel α-M and one TSKgel α-2500 manufactured by Tosoh Corp.) under the following conditions: flow rate: 1.0 ml/minute, eluate: N,N-dimethylformamide, column temperature: 35° C., standard reference material: monodispersed polystyrene

[Alkali Solubility]: A uniform film with a thickness of 2 μm was prepared on a 6-inch silicon wafer by applying a resin solution in N-methyl-2-pyrrolidone (hereafter described as “NMP”) by spin coating and heating on a hot plate at 110° C. for 3 minutes. The obtained substrate was immersed in a 2.38% tetramethylammonium aqueous solution for 300 seconds and washed with purified water for 30 seconds. After washing, the thickness of the coated film remained on the silicon wafer (remaining film thickness) was measured. The sample was evaluated as “Soluble” in alkali when the remaining film thickness was below 1 μm, and “Insoluble” in alkali when the remaining film thickness was 1 μm or more.

[Miscibility]: When mixed at a ratio shown in Table 1, the miscibility of the composition was evaluated as “Good” if a transparent and homogeneous solution was produced, and as “Bad” if a translucent or opaque solution was produced.

[Applicability]: A uniform film with a thickness of 20 μm was prepared by applying a photosensitive resin composition to a 6-inch silicon wafer by spin coating and heating on a hot plate at 110° C. for 3 minutes. If cracks and the like were generated on the coated film, the sample was evaluated as “Bad” and otherwise as “Good”.

[Patterning characteristics]: Using an aligner (MA-150 manufactured by Suss Mictotec Co.), the wafer with the coating film obtained in the applicability test was exposed to ultraviolet light at a wavelength of 350 nm from a high-pressure mercury lamp through a mask pattern at a dose of 1000 to 5000 mJ/cm². The film was then heated on a hot plate at 110° C. for 3 minutes (PEB) and developed by dipping in a 2.38 mass % tetramethylammonium hydroxide aqueous solution at 23° C. for 60 seconds. The patterning characteristics were evaluated as “Good” if the pattern conforming to the mask was formed and otherwise were evaluated as “Bad”.

[Tensile breaking elongation]: A uniform film with a thickness of 20 μm was prepared by applying a photosensitive resin composition to a PET film and heating in an oven at 110° C. for 30 minutes. The film was exposed to light with a wavelength of 350 nm at a dose of 1,000 mJ/cm² and heated in an oven at 110° C. for 30 minutes. The coated film was removed from the PET film and further heated at 250° C. for 60 minutes to obtain a cured resin. A dumbbell with a width of 5 mm was punched from the obtained cured film to produce a test specimen. The tensile breaking elongation of the produced test specimen was measured according to JIS K7113 (tensile test method of plastics).

### Synthesis Example 1

A 500 ml separable flask was charged with 19.8 g of 4,4′-diamino-3,3′-dihydroxybiphenyl (monomer “MA-1”), 7.8 g of 4,4′-diamino diphenyl ether (monomer “MB-1”), and 240 g of N-methyl-2-pyrrolidone (hereinafter described as “NMP”). After dissolving the monomers by stirring at room temperature, 32.4 g of bicyclo[2.2.2]oct-7-ene-2,3,5,6-tetracarboxylic dianhydride (monomer “MC-1”) was added. After stirring at 120° C. for five hours under nitrogen atmosphere, the mixture was heated to 180° C. to carry out a dehydration reaction for five hours. After the reaction, the reaction mixture was poured into water to cause the reaction product to precipitate. The precipitate was recrystallized, filtered, and dried under vacuum to obtain 53 g of a polymer (A-1). The molecular weight Mw of the obtained polymer (A-1) was 212,000. As a result of alkali-solubility test, the polymer (A-1) was confirmed to be “Soluble”. IR analysis confirmed absorption at 1788 cm⁻¹ indicating the presence of imide.

### Synthesis Example 2

A 500 ml separable flask was charged with 17.2 g of 4,4′-diamino-3,3′-dihydroxybiphenyl (monomer “MA-1”), 13.2 g of 4,4′-diaminophenylsulfone (monomer “MB-2”), and 240 g of NMP. After dissolving the monomers by stirring at room temperature, 16.5 g of bicyclo[2.2.2]oct-7-ene-2,3,5,6-tetracarboxylic dianhydride (monomer “MC-1”) and 13.1 g of 1,2,3,4-butane tetracarboxylic dianhydride (monomer “MC-2”) were added. After stirring at 120° C. for five hours under nitrogen atmosphere, the mixture was heated to 180° C. to carry out a dehydration reaction for five hours. After the reaction, the reaction mixture was poured into water to cause the reaction product to precipitate. The precipitate was recrystallized, filtered, and dried under vacuum to obtain 54 g of a polymer (A-2). The molecular weight Mw of the obtained polymer (A-2) was 143,000. As a result of alkali-solubility test, the polymer (A-2) was confirmed to be “Soluble”.

IR analysis confirmed absorption at 1788 cm⁻¹ indicating the presence of imide.

### Synthesis Example 3

A 500 ml separable flask was charged with 19.8 g of 4,4′-diamino-3,3′-dihydroxybiphenyl (monomer “MA-1”), 7.8 g of 1,12-dodecylenediamine (monomer “MB-3”), and 240 g of NMP. After dissolving the monomers by stirring at room temperature, 32.4 g of bicyclo[2.2.2]oct-7-ene-2,3,5,6-tetracarboxylic dianhydride (monomer “MC-1”) was added. After stirring at 120° C. for five hours under nitrogen atmosphere, the mixture was heated to 180° C. to carry out a dehydration reaction for three hours. After the reaction, the reaction mixture was poured into water to cause the reaction product to precipitate. The precipitate was recrystallized, filtered, and dried under vacuum to obtain 53 g of a polymer (A-3). The molecular weight Mw of the obtained polymer (A-3) was 64,900. As a result of alkali-solubility test, the polymer (A-3) was confirmed to be “Soluble”. IR analysis confirmed absorption at 1788 cm⁻¹ indicating the presence of imide.

### Synthesis Example 4

A 500 ml separable flask was charged with 18.6 g of 4,4′-diamino-3,3′-dihydroxybiphenyl (monomer “MA-1”), 10.8 g of monomer “MB-4”), and 240 g of NMP. After dissolving the monomers by stirring at room temperature, 30.6 g of bicyclo[2.2.2]oct-7-ene-2,3,5,6-tetracarboxylic dianhydride (monomer “MC-1”) was added. After stirring at 120° C. for five hours under nitrogen atmosphere, the mixture was heated to 180° C. to carry out a dehydration reaction for three hours. After the reaction, the reaction mixture was poured into water to cause the reaction product to precipitate. The precipitate was recrystallized, filtered, and dried under vacuum to obtain 54 g of a polymer (A-4). The molecular weight Mw of the obtained polymer (A-4) was 123,000. As a result of alkali-solubility test, the polymer (A-4) was confirmed to be “Soluble”. IR analysis confirmed absorption at 1788 cm⁻¹ indicating the presence of imide.

### Synthesis Example 5

A 300 ml separable flask was charged with 48.7 g of monomer “MA-2” and 75 g of NMP. After dissolving the monomers by stirring at room temperature, 26.3 g of 1,2,3,4-butanetetracarboxylic dianhydride (monomer “MC-2”) was added. After stirring at 120° C. for five hours under nitrogen atmosphere, the mixture was heated to 180° C. to carry out a dehydration reaction for ten hours. After the reaction, the reaction mixture was poured into water to cause the reaction product to precipitate. The precipitate was recrystallized, filtered, and dried under vacuum to obtain 69 g of a polymer (A-5). The molecular weight Mw of the obtained polymer (A-5) was 182,000. As a result of alkali-solubility test, the polymer (A-5) was confirmed to be “Soluble”. IR analysis confirmed absorption at 1788 cm⁻¹ indicating the presence of imide. The structures of the monomers used in each Synthetic Example are as follows. The monomers used in each Synthetic Example and the yield (g) and molecular weight (Mw) of the resulting polymers are shown in Table 1 and Table 2.

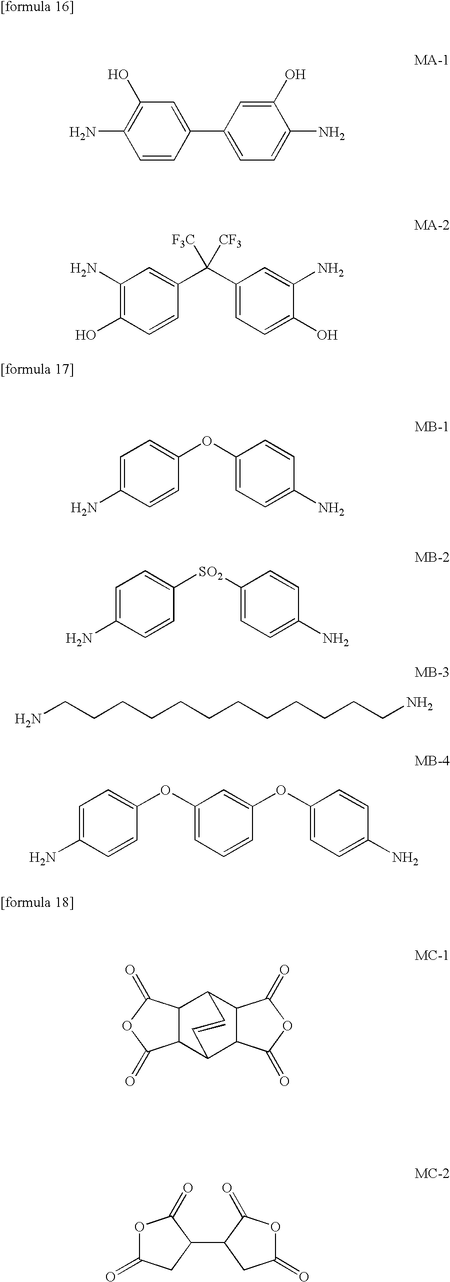

TABLE 1

| | | Monomer (molar ratio) | | | | | | | |
|---|---|---|---|---|---|---|---|---|---|
| | | MA- | | | | | | | |
| | | 1 | MA-2 | MB-1 | MB-2 | MB-3 | MB-4 | MC-1 | MC-2 |
| Syn- | 1 | 70 | | 30 | | | | 100 | |
| thesis | 2 | 60 | | | 40 | | | 50 | 50 |
| Ex- | 3 | 70 | | | | 30 | | 100 | |
| ample | 4 | 70 | | | | | 30 | 100 | |
| | 5 | | 100 | | | | | | 100 |

TABLE 2

| | | Monomer (g) | | | | | | | | NMP | Yield | | IR | Alkali |
|---|---|---|---|---|---|---|---|---|---|---|---|---|---|---|
| | | MA-1 | MA-2 | MB-1 | MB-2 | MB-3 | MB-4 | MC-1 | MC-2 | (g) | (g) | Mw | (cm⁻¹) | solubility |
| Synthesis | 1 | 19.8 | | 7.8 | | | | 32.4 | | 240 | 53 | 212000 | 1778 | Soluble |
| Example | 2 | 17.2 | | | 13.2 | | | 16.5 | 13.1 | 240 | 54 | 143000 | 1778 | Soluble |
| | 3 | 19.8 | | | | 7.8 | | 32.4 | | 240 | 53 | 64900 | 1778 | Soluble |
| | 4 | 18.6 | | | | | 10.8 | 30.6 | | 240 | 54 | 123000 | 1778 | Soluble |
| | 5 | | 48.7 | | | | | | 26.3 | 75 | 69 | 182000 | 1778 | Soluble |

### Example 1

100 parts by mass of the polymer (A-1) obtained in Synthesis Example 1, 700 parts by mass of a solvent (NMP), 2 parts by mass of a photoacid generator (B-1), and 25 parts by mass of a crosslinking agent (C-1) were mixed to obtain a photosensitive resin composition of Example 1. The photosensitive resin composition obtained was evaluated and the results of evaluation of miscibility, applicability, patterning characteristics were confirmed to be “Good”, and the tensile breaking elongation was 30%.

### Examples 2 to 11 and Comparative Examples 1 to 3

Photosensitive resin compositions (Examples 2 to II and Comparative Examples 1 to 3) were obtained in the same manner as in Example 1, except for using the components according to the formulation shown in Table 3. The results of evaluation of miscibility, applicability, patterning characteristics, and tensile breaking elongation of the resulting photosensitive resin compositions are shown in Table 4. The abbreviated designations in Table 3 are as follows.

### (Phenol Resin)

P-1: Cresol novolak resin with m-cresol/p-cresol molar ratio of 60/40 (polystyrene reduced weight average molecular weight=8700)
P-2: Phenol-xylylene glycol dimethyl ether condensed resin (“MILEX (registered trademark) XLC-3L” manufactured by Mitsui Chemicals, Inc.)

### (Solvent)

NMP: N-Methyl-2-pyrrolidone
EL: Ethyl lactate

### (Photoacid Generator)

### B-1: Styryl-bis(trichloromethyl)-s-triazine

B-2: 4,7-Di-n-butoxy-1-naphthyltetrahydrothiophenium trifluoromethanesulfonate
B-3: 2-2-[-(Furan-2-yl)ethenyl]-4,6-bis(trichloromethyl)-s-triazine (“TFE-triazine” (commercial name) manufactured by Sanwa Chemical Co., Ltd.)
B-4: 2-[2-(5-Methylfuran-2-yl)ethenyl]-4,6-bis(trichloromethyl)-s-triazine (“TME-triazine” (commercial name) manufactured by Sanwa Chemical Co., Ltd.)

### (Crosslinking Agent)

C-1: Hexamethoxymethyl melamine (“Cymel 300” (commercial name) manufactured by Cytec Industries, Inc.)
C-2: Tetramethoxymethyl glycoluril (“Cymel 1174” (commercial name) manufactured by Cytec Industries, Inc.)
C-3: “Epicoat 828” (registered trademark) manufactured by Japan Epoxy Resins Co., Ltd.

TABLE 3

| | | Polyimide | | | | | | Photoacid | | Crosslinking | |
|---|---|---|---|---|---|---|---|---|---|---|---|
| | | resin | | Phenol resin | | Solvent | | generator | | agent | |
| | | | Part(s) | | Part(s) | | Part(s) | | Part(s) | | Part(s) |
| | | Type | by mass | Type | by mass | Type | by mass | Type | by mass | Type | by mass |
| Example | 1 | A-1 | 100 | | | NMP | 700 | B-1 | 2 | C-1 | 25 |
| | 2 | A-1 | 100 | | | NMP | 650 | B-2 | 4 | C-2 | 20 |
| | 3 | A-1 | 50 | P-1 | 50 | NMP | 300 | B-1 | 1 | C-1 | 15 |
| | 4 | A-1 | 80 | P-2 | 20 | NMP | 350 | B-2 | 2 | C-2 | 10 |
| | 5 | A-2 | 100 | | | NMP | 500 | B-1 | 1.5 | C-1 | 20 |
| | 6 | A-2 | 100 | | | NMP | 500 | B-2 | 1.5 | C-2 | 15 |
| | 7 | A-2 | 50 | P-1 | 50 | NMP | 300 | B-1 | 0.7 | C-1 | 20 |
| | 8 | A-2 | 90 | P-2 | 10 | NMP | 250 | B-2 | 2 | C-2 | 10 |
| | 9 | A-3 | 80 | P-1 | 20 | NMP | 210 | B-3 | 1 | C-1 | 15 |
| | 10 | A-4 | 80 | P-2 | 20 | NMP | 270 | B-3 | 1.2 | C-2 | 15 |
| | 11 | A-5 | 100 | | | NMP | 270 | B-4 | 1 | C-1 | 15 |
| Comparative | 1 | A-1 | 100 | | | NMP | 700 | B-1 | 1 | C-3 | 30 |
| Example | 2 | A-2 | 100 | | | NMP | 500 | B-2 | 1 | C-3 | 15 |
| | 3 | | | P-2 | 100 | EL | 120 | B-1 | 1 | C-1 | 20 |

TABLE 4

| | | | | | Tensile |
|---|---|---|---|---|---|
| | | | | | breaking |
| | | | | Patterning | elongation |
| | | Miscibility | Applicability | characteristics | (%) |
| Example | 1 | Good | Good | Good | 30 |
| | 2 | Good | Good | Good | 35 |
| | 3 | Good | Good | Good | 27 |
| | 4 | Good | Good | Good | 25 |
| | 5 | Good | Good | Good | 32 |
| | 6 | Good | Good | Good | 26 |
| | 7 | Good | Good | Good | 24 |
| | 8 | Good | Good | Good | 27 |
| | 9 | Good | Good | Good | 26 |
| | 10 | Good | Good | Good | 27 |
| | 11 | Good | Good | Good | 20 |
| Comparative | 1 | Bad | — | — | — |
| Example | 2 | Bad | — | — | — |
| | 3 | Good | Good | Good | 2 |

### INDUSTRIAL APPLICABILITY

The photosensitive resin composition of the present invention is suitable for a surface protecting film, an interlayer dielectric film, and an insulation film for high density mounting substrates, and very useful in industry.

1: A photosensitive resin composition comprising (A) a polyimide resin, (B) a photoacid generator, and (C) a crosslinking agent having an alkoxyalkylated amino group.

2: The photosensitive resin composition according to claim 1, further comprising a phenol resin.

3: The photosensitive resin composition according to claim 1, wherein the polyimide resin (A) is alkali-soluble.

4: The photosensitive resin composition according to claim 1, wherein the polyimide resin (A) comprises a repeating unit of the following formula (1), 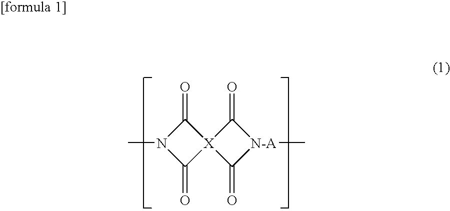
wherein X represents a tetravalent aromatic hydrocarbon group or a tetravalent aliphatic hydrocarbon group and A represents a divalent group having a hydroxyl group.

5: The photosensitive resin composition according to claim 4, wherein X in the formula (1) is a tetravalent aliphatic hydrocarbon group.

6: The photosensitive resin composition according to claim 4, wherein A in the formula (1) is a group shown by the following formula (2), 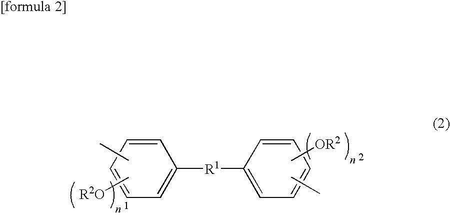
wherein R¹ represents at least one group selected from the group consisting of a single bond, an oxygen atom, a sulfur atom, a sulfone group, a carbonyl group, a methylene group, a dimethylmethylene group, and a bis(trifluoromethyl)methylene group, R² individually represents a hydrogen atom, an acyl group, or an alkyl group, and n¹ and n² represent integers from 0 to 2, provided that at least one of n¹ and n² is 1 or more and at least one of R² is a hydrogen atom.
